(19) United States
(12) Patent Application Publication
(10) Pub. No.: US 2018/0315415 A1
(43) Pub. Date: Nov. 1, 2018

(54) VIRTUAL ASSISTANT WITH ERROR IDENTIFICATION

(71) Applicant: SoundHound, Inc., Santa Clara, CA (US)

(72) Inventors: Glenda Mosley, San Jose, CA (US); Rainer Leeb, San Jose, CA (US); Stephanie Lawson, San Jose, CA (US); Kamyar Mohajer, San Jose, CA (US)

(73) Assignee: SoundHound, Inc., Santa Clara, CA (US)

(21) Appl. No.: 15/497,208

(22) Filed: Apr. 26, 2017

(51) Int. Cl. G10L 15/01; G10L 15/06

(52) U.S. Cl. CPC G10L 15/01; G10L 2015/0638; G10L 2015/0631; G10L 15/063

(57) ABSTRACT

Virtual assistants provide results in response to user commands and analyze user utterances in response to the result. The analysis can interpret words, recognized from the utterance, as being negative indicators that imply user dissatisfaction. Virtual assistants request follow-up information from users. Analysis also interprets words as indicators of clarification and collect information to add to a knowledgebase. Machine learning algorithms use recognized words to train a behavioral model to improve results. Virtual assistants also infer, from replacement of words in successive commands, that earlier commands had word recognition errors and infer, from addition of words, that earlier commands had interpretation errors. Virtual assistants act locally or as devices in communication with servers.

### FIELD OF THE INVENTION

The present invention is in the field of systems that are speech-enabled to process natural language utterances and, more specifically, to systems that address identification of speech recognition and natural language understanding errors.

### BACKGROUND

Virtual assistants have become commonplace. They receive spoken commands, including queries for information, and respond by performing specified actions, such as moving, sending messages, or answering queries. Unfortunately, even the best conventional virtual assistants sometimes behave in ways that is not what their user wanted. That occurs for various reasons, such as the virtual assistant does not have an ability that the user wants, the user does not know how to command the virtual assistant, or the virtual assistant has an unfriendly user interface. Regardless of the reason, conventional virtual assistants occasionally act in ways that give unsatisfactory results to their users.

### SUMMARY OF THE INVENTION

Some embodiments of the present invention use user utterances to detect whether a previous action gave the user a satisfactory or unsatisfactory result. Furthermore, some embodiments respond to feedback from users. Some embodiments follow-up with users to request clarification or explanation. Some embodiments learn from users by receiving information from user utterances. Some embodiments adapt their behavior according to what they learn from users. Some embodiments create and update knowledgebases. Some embodiments use natural language interpretations of user utterances. Some embodiments compare multiple utterances to identify differences and, according to whether differences are replacements or additions, infer that a word recognition or interpretation error, respectively, caused dissatisfaction. Some embodiments infer a speech recognition error from a word replacement difference between utterances. Some embodiments infer an interpretation error from a word addition difference between utterances.

According to some embodiments, a virtual assistant uses a computer processor to execute code stored on a non-transitory computer readable medium such that the computer processor causes the virtual assistant to: receive a command; perform an action responsive to the command to produce a result; receive an utterance from a user; recognize words in the utterance; analyze the words to produce a satisfaction indicator; and store the satisfaction indicator in a database.

According to some embodiments, a virtual assistant uses a computer processor to execute code stored on a non-transitory computer readable medium such that the computer processor causes the virtual assistant to: receive a first utterance; recognize a first sequence of words from the first utterance; recognize an alternative sequence of words from the first utterance; interpret the first sequence of words to create a first interpretation; interpret the first sequence of words to create an alternative interpretation; receive a second utterance; recognize a second sequence of words; identify, in the second sequence of words, a replacement or addition of words relative to the first sequence of words and indicate a speech recognition or interpretation error respectively; compare the second sequence of words to the alternative sequence of words to indicate a speech recognition error; and compare the second interpretation to the alternative interpretation to indicate an interpretation error.

### BRIEF DESCRIPTION OF THE DRAWINGS

FIG. 1 illustrates a method according to an embodiment of the invention.

FIGS. 2A, 2B, 2C and 2D illustrate examples of speech-enabled devices according to various embodiments of the invention.

FIG. 3 illustrates a method of analyzing words according to an embodiment of the invention.

FIG. 4 illustrates negative indicator words according to an embodiment of the invention.

FIG. 5 illustrates a method including performing a second action according to an embodiment of the invention.

FIG. 6 illustrates a method including requesting and receiving follow-up information to write to a computer-readable medium according to an embodiment of the invention.

FIG. 7 illustrates a method of analyzing words to recognize new information according to an embodiment of the invention.

FIG. 8 illustrates clarification indicator words according to an embodiment of the invention.

FIG. 9 illustrates a method including maintaining a knowledgebase according to an embodiment of the invention.

FIG. 10 illustrates a method of interpreting words according to an embodiment of the invention.

FIG. 11 illustrates a method including performing machine learning on a behavioral model used to determine action behavior according to an embodiment of the invention.

FIG. 12 illustrates a method of a virtual assistant with error identification and storing of word sequence history according to an embodiment of the invention.

FIG. 13 illustrates a table of phoneme abbreviations.

FIG. 14 illustrates a mobile phone with a virtual assistant with a word sequence recognition error according to an embodiment of the invention.

FIGS. 15A and 15B illustrate word replacement analysis according to an embodiment of the invention.

FIG. 16 illustrates word replacement with a clarification indicator according to an embodiment of the invention.

FIG. 17 illustrates minimal word replacement according to an embodiment of the invention.

FIG. 18 illustrates a method of a virtual assistant with error identification and storing of history of interpretations of commands according to an embodiment of the invention.

FIG. 19 illustrates a mobile phone with a virtual assistant with an interpretation error according to an embodiment of the invention.

FIG. 20 illustrates word addition analysis according to an embodiment of the invention.

FIG. 21 illustrates a virtual assistant system that uses client-server coupling according to an embodiment of the invention.

FIGS. 22A and 22B illustrate examples of computer readable media according to an embodiment of the invention.

FIGS. 23A AND 23B illustrate a chip according to an embodiment of the invention.

FIG. 24 illustrates a functional diagram of a server according to an embodiment of the invention.

FIG. 25 illustrates a functional diagram of system-on-chip according to an embodiment of the invention.

### DETAILED DESCRIPTION

All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” or similar language means that a particular aspect, feature, structure, or characteristic described in connection with the embodiment is included in at least one embodiment. Thus, appearances of the phrases “in one embodiment,” “in at least one embodiment,” “in an embodiment,” “in certain embodiments,” and similar language throughout this specification may, but do not necessarily, all refer to the same embodiment or similar embodiments.

Embodiments of the invention described herein are merely exemplary, and should not be construed as limiting of the scope or spirit of the invention as it could be appreciated by those of ordinary skill in the art. The disclosed invention is effectively made or used in any embodiment that comprises any novel aspect described herein. All statements herein reciting principles, aspects, and embodiments of the invention are intended to encompass both structural and functional equivalents thereof. It is intended that such equivalents include both currently known equivalents and equivalents developed in the future.

Furthermore, to the extent that the terms “including”, “includes”, “having”, “has”, “with”, or variants thereof are used in either the detailed description and the claims, such terms are intended to be inclusive in a similar manner to the term “comprising”.

### Terminology

A virtual assistant is any machine that assists a person and that the person can control using speech. Some examples include a mobile phone app that answers questions and identifies ambient playing recorded music, a speech-enabled household appliance, a watch that records its wearer's activity, an automobile that responds to voice commands, a robot that performs laborious tasks, and an implanted bodily enhancement device.

Virtual assistants receive commands from users. In some embodiments, commands comprise arguments. Virtual assistants perform commands issued by voice. Some embodiments accept commands as text, gestures, or selections of choices. In response to commands, virtual assistants perform responsive actions that produce responsive results. For example, an action of a virtual assistant that answers questions is to provide an answer as a result. Some such virtual assistants provide the answer result as synthesized speech. An action of a household robot is to follow its owner as a result. Some actions of voice-enabled automobiles include and result in opening and closing its windows and turning on and off its heater.

Users observe the result of the actions that are responsive to their commands, and speak utterances. Utterances include spoken sequences of words. Various embodiments receive utterances from users, such as by sampling audio captured by one or more microphones. Embodiments recognize words using speech recognition. Many methods of speech recognition are known in the art and applicable to various embodiments.

Users can feel satisfied with the results from their commands, dissatisfied, or neutral. Various embodiments attempt to infer the user's satisfaction or dissatisfaction from the following utterance. Embodiments do so by analyzing the words to produce a satisfaction indicator. In some embodiments, the satisfaction indicator is a 1-bit Boolean value in which a “zero” value indicates satisfaction and a “one” value indicates dissatisfaction. In some embodiments, the satisfaction indicator is a 1-bit Boolean value in which a “zero” value indicates dissatisfaction and a “one” value indicates satisfaction. Some embodiments represent degrees of satisfaction using a multi-bit number. Some embodiments include the satisfaction indicator within a data structure that represents the results of the action as being negative and/or positive. Some embodiments transform the satisfaction indicator into a secondary data format or create a secondary data element comprising the information of the satisfaction indicator.

Some embodiments store records of satisfaction indicators in databases. The stored satisfaction indicators are useful for data analysts to assess system performance and user satisfaction. The stored satisfaction indicators are also useful for machine learning algorithms to automatically improve system performance.

Negative indicator words are words that, in some context, indicate that a previous action performed by a virtual assistant was unsatisfactory. In particular, the action that the virtual assistant performed is one that did not satisfy its user. For example, the word “no” can be a negative indicator since it is a likely user utterance if a virtual assistant says “the sky is green”. The word “stop” can be a negative indicator since it is a likely user utterance if a voice-enabled automobile starts opening its windows when a passenger asks to turn on the heat. Different virtual assistants have different sets of negative indicator words. For example, although the word “stop” is a negative indicator for a car, “stop” is a normal command for a music player.

Words, as recognized by speech recognition, are n-grams of phonemic tokens recognized from phoneme sequences. N-grams are sequences of one or more tokens with a unique meaning. Text transcriptions are one way of representing words.

The term “module” as used herein may refer to one or more circuits, components, registers, processors, software subroutines, or any combination thereof.

### Handling Negative Indicators

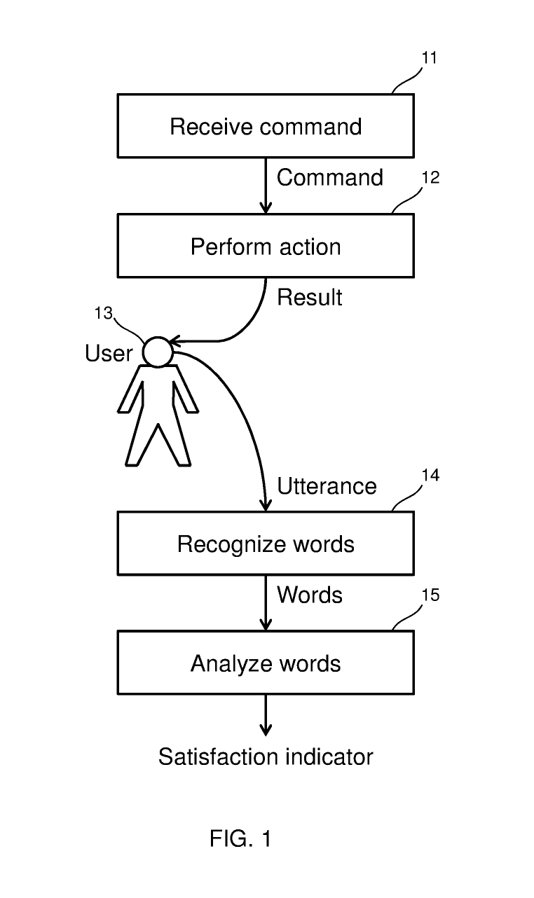

FIG. 1 shows a process, according to one embodiment, for a virtual assistant. The process or method begins with receiving a command in step 11. Some embodiments accept commands as speech from a user, some as text of words entered by a user, some as choices of buttons or menu items, some as gestures by body parts such as arms, fingers, or eyelids, and some accept command in multiple modes. Some embodiments accept commands from a person and perform an action for the person. Some embodiments accept commands from one person in order to perform an action on another person. Some embodiments accept commands from one person for the benefit—or harm—of another person.

The embodiment of FIG. 1, in step 12, performs an action, as indicated by the command, and thereby produces a result. An embodiment for answering trivia questions accepts questions as its commands, looks up information as its action, and provides answers as a result. An embodiment for playing music accepts a song name as a command, chooses the specified song as its action, and plays the song as a result. An embodiment for driving accepts a destination as its command, drives as its action, and arrives at the destination as a result. An embodiment for assisting with domestic chores accepts specific tasks as its commands, performs the specified task as its action, and has its accomplishment as a result. An embodiment for intracorporeal surgery accepts specification of incision locations as commands, cuts the specified organ location as an action, and produces an incision as a result. An embodiment for interrogation accepts a script as a command, poses questions to an interrogatee as an action, and creates opportunities for providing information as a result.

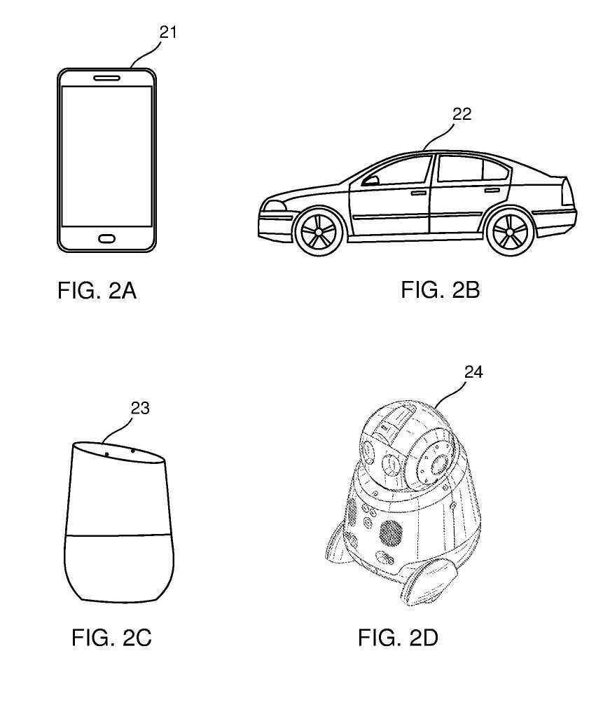

FIG. 2 shows some example embodiments of speech-enabled virtual assistants according to different embodiments. FIG. 2A shows a mobile phone 21. FIG. 2B shows an automobile 22. FIG. 2C shows a countertop music player. FIG. 2D shows a domestic robot.

Some embodiments function by running software on general-purpose programmable processors. However, some embodiments that are power-sensitive and some embodiments that require especially high performance for neural network algorithms and statistical language model analysis use hardware optimizations. Some embodiments use application-customizable configurable processors in specialized systems-on-chip, such as ARC processors from Synopsys and Xtensa processors from Cadence. Some embodiments use dedicated hardware blocks burned into field programmable gate arrays (FPGAs). Some embodiments use arrays of graphics processing units (GPUs). Some embodiments use application-specific-integrated circuits (ASICs) with customized logic to give best performance.

Hardware blocks and custom processors instructions, co-processors, and hardware accelerators perform neural network processing or parts of neural network processing algorithms with particularly high performance and power efficiency. This is important for maximizing battery life of battery-powered devices and reducing heat removal costs in data centers that serve many client devices simultaneously.

In the embodiment of FIG. 1, the user 13 receives the result and utters an utterance of spoken words. In some cases, the user 13 indicates appreciation, such as by saying “Thank you.” In some cases, the user 13 gives a command, such as “Play the next song.” In some cases, the user 13 asks a follow-up question, such as “What route are we taking?” In some cases, the user 13 provides feedback, such as “That hurts.”

The embodiment of FIG. 1, in step 14, recognizes the words from the user utterance. Various embodiments do so using various methods of speech recognition. Various embodiments support different languages or combinations of languages. Various embodiments support different sets of vocabulary. In step 15, the embodiment analyzes the words to produce a satisfaction indicator, which can be stored in a database. The satisfaction indicator, as discussed below, can be used to determine if the action performed, which is in response to receiving a command, was adequate or responsive the user's spoken utterance. In this way, the various embodiments disclosed herein can use the satisfaction indicator to improve performance of actions and/or improve responses Different types of analysis provide different degrees of accuracy, efficiency, and speed as required for different applications.

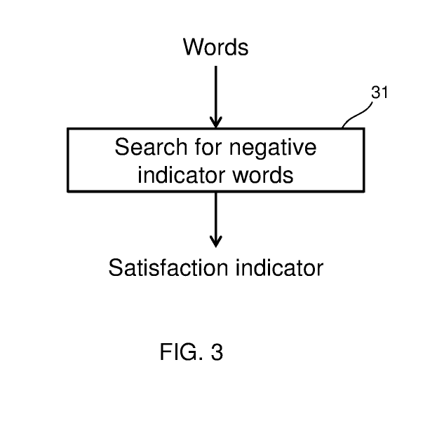

FIG. 3 shows a method of analysis according to one embodiment. Analysis step 31 receives words and searches for specific negative indicator words. If the embodiment finds one or more negative indicators words, it outputs a negative satisfaction indicator, which indicates that the user is dissatisfied with the result of action, at step 12 of FIG. 1. If the embodiment finds no negative indicators words, it outputs a positive satisfaction indicator, which indicates that the user is satisfied with the result of action, at step 12 of FIG. 1.

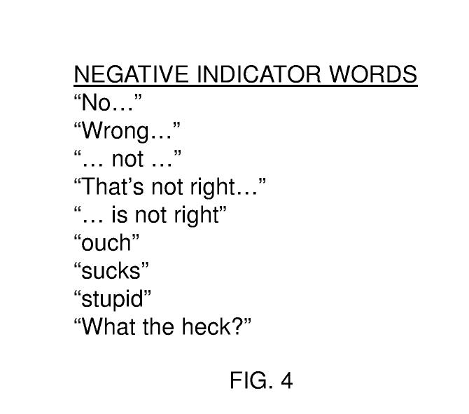

FIG. 4 shows some examples of negative indicator words, including: “no”, “wrong”, “not”, “ouch”, “sucks”, and “stupid” as well as n-grams of multiple words, such as “that's not right”, “is not right”, and “what the heck?”. Some embodiments distinguish the negative indicator words as such only when they are in certain positions within the words sequence recognized from the utterance. For example, in some cases “no” at the beginning of an utterance is a negative indicator, but “no” in the middle of an utterance is not because utterances such as, “there is no place like home” is not negative. Some embodiments treat some words as generally negative, but not so if they are accompanied by specific other words, such as “problem” coming after the word “no”.

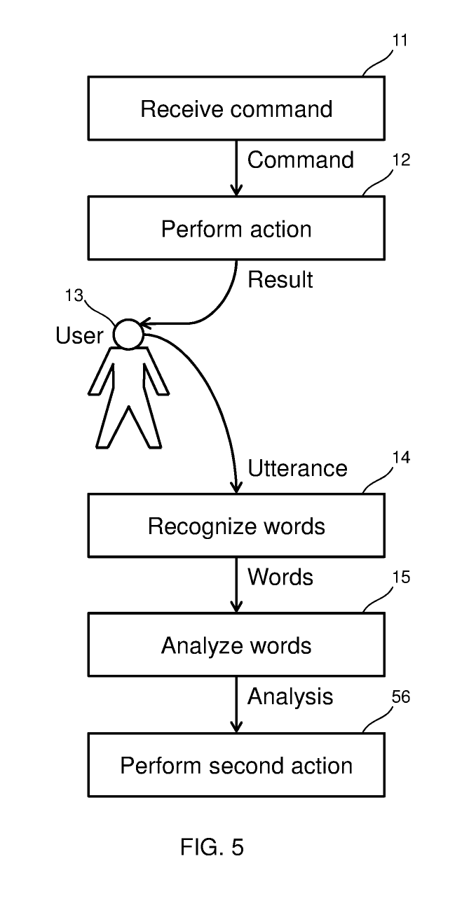

FIG. 5 shows an embodiment of a process or method that follows steps 11, 12, 14, and 15 relating to user 13. It further proceeds, in step 56, to perform a second action in response to the analysis of words. For example, in a scenario in which the command is to place a phone call to a specific person, the action initiates a call to the wrong person. The recognized words are, “No, Andy Marco, not Ann DiMarco”, and the analysis indicates dissatisfaction, then the embodiment terminates the phone call as second action 56. For example, if the action 12 is to start moving, the recognized words include a negative indicator word “stop”, second action 56 is to stop moving. If the action 12 is to start playing a song by the band Nickelback, the recognized words include a negative indicator word “sucks”, second action 56 is to skip to playing a song by a different artist.

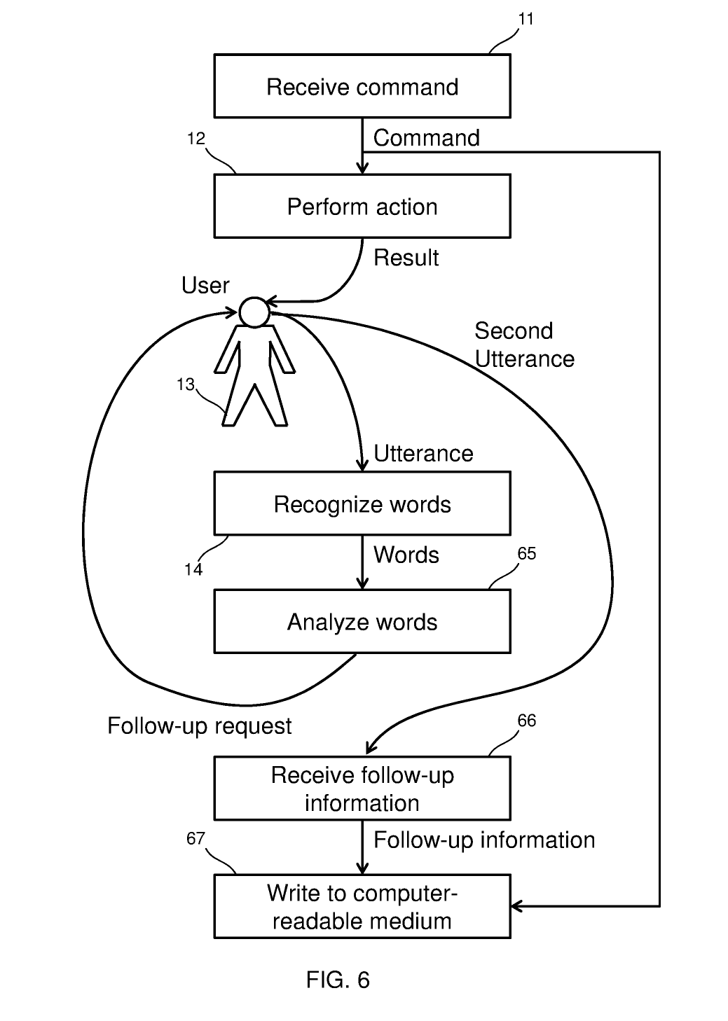

FIG. 6 shows an embodiment that interacts with the user to get feedback. The embodiment follows steps 11, 12, and 14, relating to user 13. An analysis step 65 analyzes the words with respect to negative indicators. Upon finding a negative indicator, step 65 produces a request to the user to provide follow-up information. For example, if the user says, “That's not the right way” to a self-driving car, and step 65 recognizes “not” as a negative indicator word, it proceeds to ask the user what is the best way to go. For example, if a grocery shopping virtual assistant offers a plain kind of cereal, the users says, “I don't like that kind”, and the virtual assistant recognizes the words, “don't like” as a negative indicator, it will ask the user, “What kind do you like?”

The embodiment of FIG. 6 proceeds, at step 66, to accept a second utterance from the user and to receive follow-up information from the utterance. The embodiment proceeds to step 67, in which it writes the command and the follow-up information to a computer-readable medium. This is useful for system analysts, engineers, and administrators to identify problems or opportunities for improving the system. It is also useful for a system to gather personal information about the user. Such personal information can be useful to provide results that are more useful in the future and to profile the user, such as for providing relevant advertisements.

Clarification indicator words are a type of negative indicator words. Clarification indicator words are words that, in some context, indicate that a user's utterance includes information that might be useful to the system. For example, the word “actually” is a likely user utterance if the user is providing information believed to be correct that the system should know.

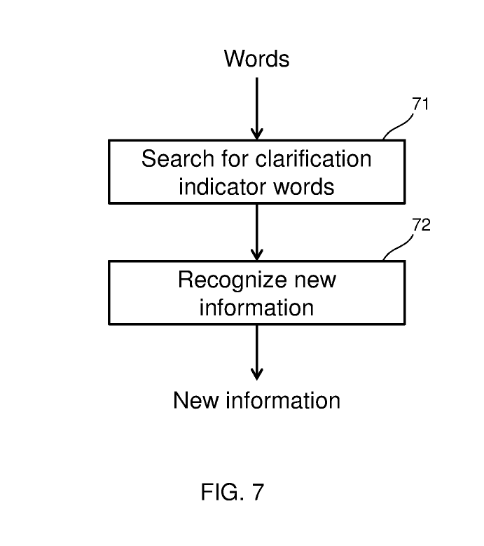

FIG. 7 shows an embodiment that analyzes words to extract new useful information. The embodiment receives words and, at step 71, searches for clarification indicator words. If it finds any such word, it proceeds to step 72 and the embodiment recognizes new information and provides it to a virtual assistant system. For example, if a user commands a virtual assistant, “How far is the farthest planet from the sun?” and the virtual assistant provides a result that “Pluto is 3.67 billion miles from the sun”, and the user utters, “Actually, Pluto is not a planet.”, the virtual assistant recognizes the clarification indicator word, “actually”, and captures the remainder of the utterance, “Pluto is not a planet”, as new information. For example, if a user commands a virtual assistant, “Take me to the nearest store.” and the virtual assistant provides a result that it starts driving to the nearest convenience store, and the user utters, “I mean, I want to go to the nearest grocery store”, the virtual assistant recognizes the clarification indicator n-gram, “I mean”, and captures the remainder of the utterance, “I want to go to the nearest grocery store”, as new information.

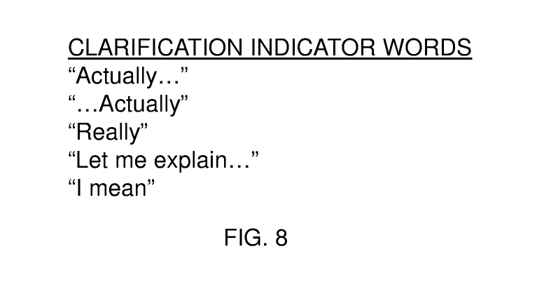

FIG. 8 shows some examples of clarification indicator words, including “actually” and “really” as well as an n-grams of multiple words, “let me explain” and “I mean”. Some embodiments distinguish the clarification indicator words as such only when they are in certain positions within the word sequence recognized from the utterance.

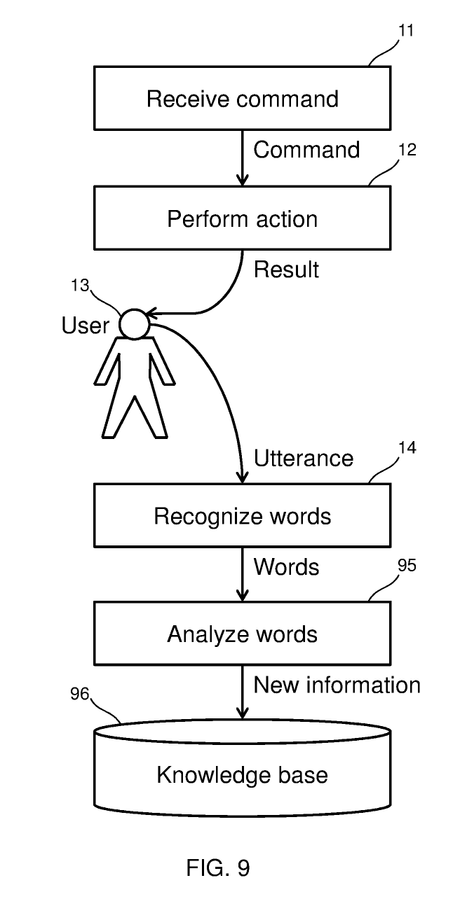

FIG. 9 shows an embodiment that detects new information and uses it to build and maintain a knowledgebase. The embodiment follows steps 11, 12, and 14, relating to user 13. It then proceeds to an analysis step 95, in which it analyzes the words with respect negative indicators. Some embodiments analyze only clarification indicators, which are the negative indicators that most reliably accompany new information. When the analysis of step 95 detects a negative indicator, it interprets all words in the utterance using a natural language processing algorithm, to extract semantic information, such as entities, attributes that they have, the values of attributes, and the relationships between entities. Various known natural language processing algorithms are appropriate. In some embodiments, the natural language processing distinguishes between questions and statements in utterances, and only attempts to extract new information from statements.

The embodiment of FIG. 9 proceeds, in its analysis step 95, to search a knowledgebase 96 for facts that are comparable to the new information, such as because they contain the same entities and relationships. Various appropriate ways to represent facts within knowledgebases are known. If the analysis finds no facts comparable to the new information, it adds the new information to the knowledgebase. Some embodiments tag facts in the database as confirmed true or not. Some embodiments tag facts with a degree of confidence. Some embodiments tag facts in the database as being personal to one or a group of users.

If analysis step 95 finds a fact comparable to new information, and the new information concurs with the fact, the embodiment increases its degree of confidence. If analysis step 95 finds a fact comparable to new information, but the new information contradicts the fact, the embodiment decreases its degree of confidence in the fact. In such a case, some embodiments respond to the user with a follow-up request as in the embodiment of FIG. 6. In such a case, some embodiments flag the fact for a human curator to investigate. In such a case, some embodiments add a contradictory fact, having the new information, to the knowledgebase. Some embodiments indicate context with facts in the knowledgebase. Such embodiments may include facts that would be contradictory, except for having different contexts in which they might each be true.

Some embodiments act simply on words recognized from speech, such as from a speech recognition module. Some embodiments interpret the speech, such as by using natural language processing, to determine an interpretation. An interpretation is an instance of a data structure. Interpretations, according to some embodiments, include a sentiment, which can be negative. Interpretations, according to some embodiments, do not include a sentiment, but some such embodiments can infer a sentiment by analyzing the interpretation.

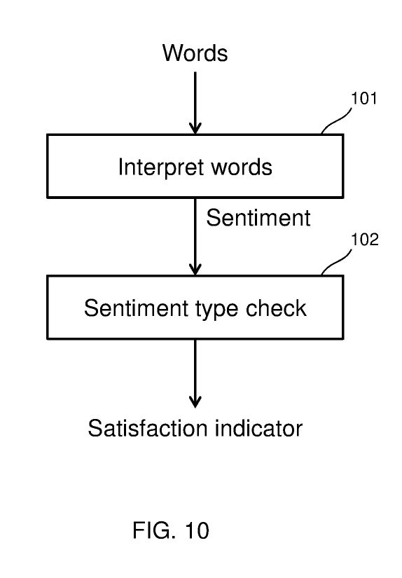

FIG. 10 shows steps for analysis in an embodiment that uses sentiment analysis. The embodiment performs interpretation using natural language processing. Interpretation, according to some embodiments extracts semantic information as in the embodiment of FIG. 9. Interpretation, according to some embodiments, measures a sentiment, without regard to specific new information. In the embodiment of FIG. 10, an interpretation step 101 computes a sentiment value. Various embodiments represent sentiments in different ways. Some embodiments use multi-dimensional representations of different types of emotions. Some embodiments use a scale of positive to negative value. The embodiment of FIG. 10 proceeds to step 102, in which it checks for the type of sentiment and computes a resulting satisfaction indicator. N-grams such as “thank you” and “okay” are simple indicators of positive sentiments, whereas “no” and “wrong” are simple indicators of negative sentiments. More sophisticated algorithms of n-gram sentiment analysis are possible, and some embodiments use machine learning to extract sentiments with word combinations.

Some embodiments build a vector of n-grams in a large set of n-grams and apply a function, such as a simple ratio of positive to negative satisfaction indicators, to associate sentiments with n-grams. Some embodiments build vectors of specific entities, as determined by interpretation of utterances. Some examples of entities are domains of conversation, specific brands, specific advertisements, specific geolocations, specific retail businesses, and specific people. Some such embodiments use functions of satisfaction indicators to associate sentiments with entities. Some embodiments, similarly, associate sentiments with values of attributes of entities. For example, an utterance about a bank account balance would have a more positive sentiment level if the amount is one million dollars than if the amount is thirty-five cents.

Some embodiments associate satisfaction indicators to geolocations and ranges of geolocation. Some such embodiments use that information to detect word sequence errors that are indicative of regional accents. Accordingly, some embodiments can build accurate accent characterization maps with precision as fine as neighborhood blocks and individual buildings and with more accuracy than named geographical accents.

Some embodiments detect user environment when the user gives satisfaction indication feedback. This provides information on the level of satisfaction with the system in environments such as homes, travel, work, and shopping. Some embodiments, give more weight to feedback given in environments where it is less convenient, such as at work or shopping, and less weight to feedback given in environments where it is more convenient such as home or travel.

Some embodiments associate satisfaction indicators with meta-attributes of utterances. For example, a word count, an analysis of complexity if utterance words, duration of utterance, background noise level in utterance audio, and number of word sequence and interpretation hypotheses above thresholds.

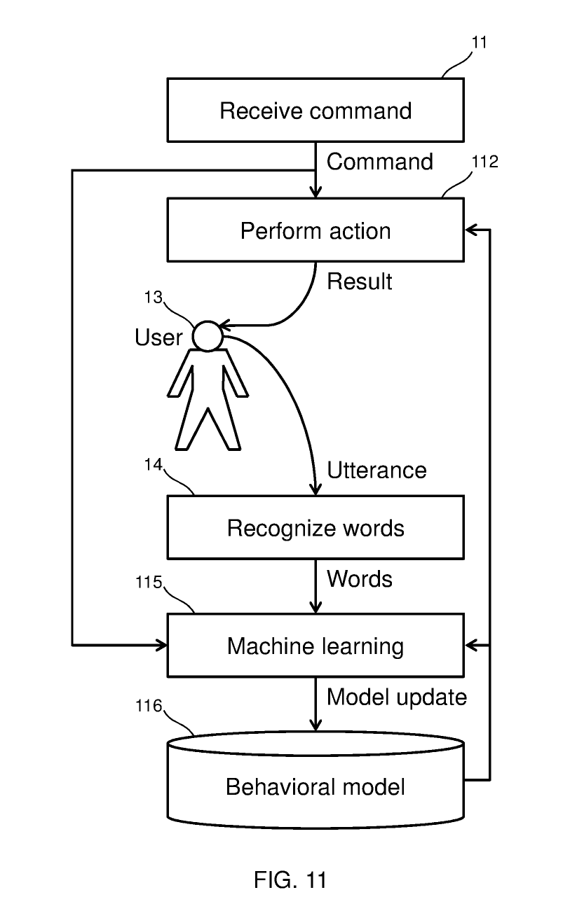

FIG. 11 shows an embodiment that uses machine learning to improve the results of the actions performed. The embodiment follows steps 11, through an action step 112, to step 14, relating to user 13. It then proceeds to a machine learning step 115. The machine learning step takes the command and the recognized words from the user utterance. It uses a behavioral model 116 of the system to determine the action performed and the result. Some embodiments take the result into the machine learning step 115, and thereby does not need to compute the result by applying the behavioral model to the command.

The embodiment of FIG. 11 proceeds to analyze the words for their degree of satisfaction. According to the degree of satisfaction, the machine learning step 115 modifies the behavioral model 116. Action step 112 takes in the behavioral model and the command and processes the command according to a function designated by the behavioral model 116.

Various embodiments use various particular machine learning algorithms and types of machine learning algorithms. Some examples are supervised and unsupervised algorithms such as regressions, k-nearest neighbor, decision trees, and Bayesian algorithms.

Some embodiments that use machine learning, upon receiving a command to respond to the question, “How high is Denver?”, initially give a temperature result. In response to a negative indicator in a responding user utterance, the embodiment retrains a behavioral model so that the action, in response to that question, gives an elevation result instead, since an elevation-related interpretation of the command is nearly as likely as a weather-related interpretation. Some embodiments that use machine learning, upon receiving a command to respond to the question, “What is the stock price of Alibaba?”, initially give an amount of dollars. In response to a responding user utterance, “Actually, I want to know the price in Chinese renminbi.” the embodiment retrains its behavioral model so that the action, in response to future price questions, gives results in currency units of Chinese renminbi. If the user proceeds to give a command to respond to the question, “How much does a Snickers bar cost?”, the embodiment responds in units of renminbi. If the user proceeds with an utterance, “No. What is it in dollars?”, the embodiment trains its behavioral model to give stock price quotes in units of Chinese renminbi, but food item prices in units of dollars.

### Identifying Word Sequence Errors

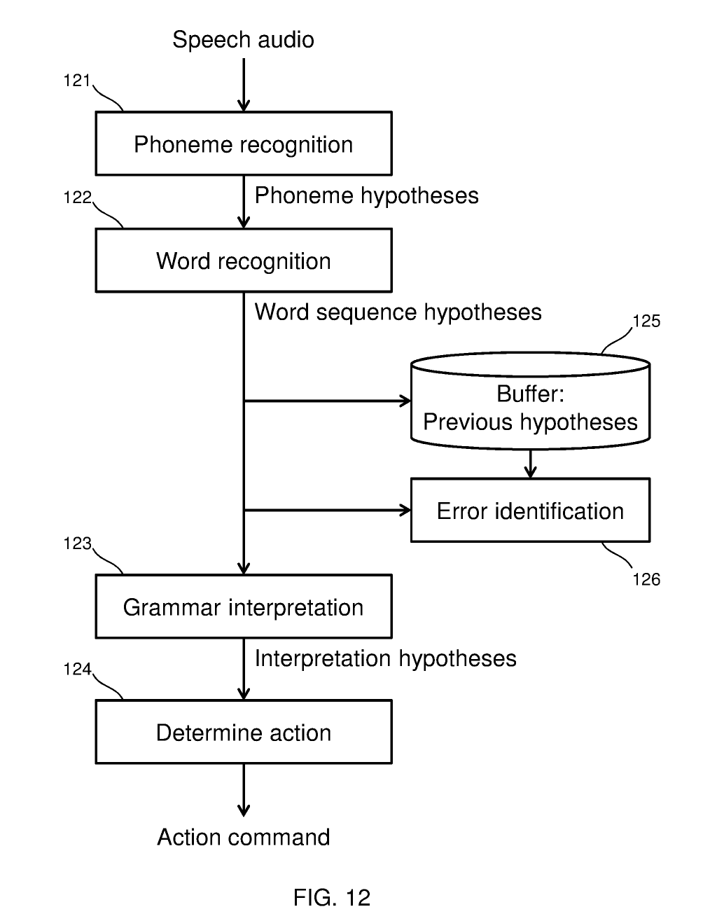

FIG. 12 shows a method for receiving voice commands, as within step 11. It begins by receiving digitized speech audio. Some embodiments, digitally process the speech audio captured from a microphone using signal-processing algorithms such as transforms, filtering, and compression. The method begins with phoneme recognition step 121. The embodiment analyzes the speech audio to determine changes in the relative distribution of energy across a frequency spectrum in order to hypothesize spoken phonemes and their transitions. Some embodiments use neural networks, with trained acoustic models, to hypothesize sequences of phonemes. Such embodiments compute a score for each of multiple hypotheses, and adjust the score as they process each new audio frame. Step 121 produces a set of phoneme sequence hypotheses and associated scores.

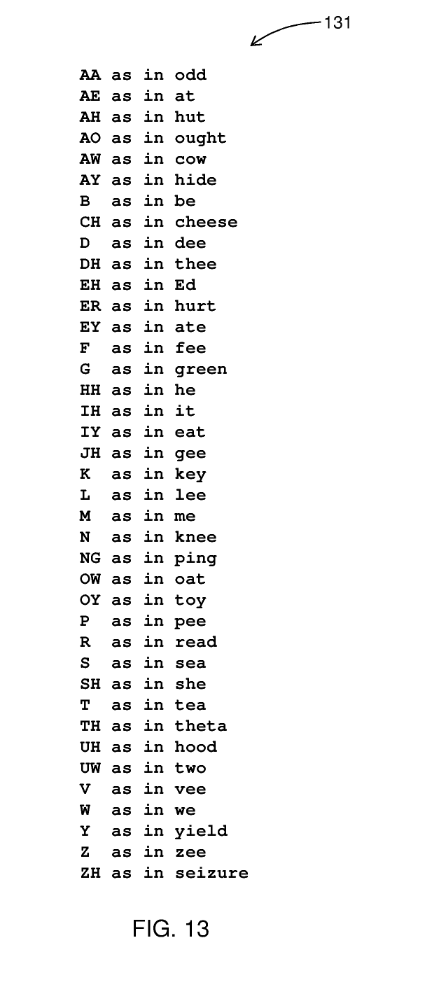

FIG. 13 shows a list of symbols representing each of 40 widely recognized phonemes of the English language. One particular audio sequence might yield many phoneme sequence hypotheses with reasonably high scores, four of which are:

1: <G AO N W IH ZH AH W IH N D>

2: <G AO N W IH N DH AH W IH N D>

3: <G AO N W IH TH IH N W IH N D>, and

4: <G AO N W IH TH DH AH W IH N D>.

All four hypotheses are similar, but with a difference in the middle resulting from transient noise in the audio, such as banging or a wind gust.

Referring again to FIG. 12, step 122 receives the phoneme sequence hypotheses and associated scores and performs word sequence recognition. There are many appropriate algorithms to do so. The embodiment of FIG. 12 uses a pronunciation dictionary to map, for each phoneme sequence hypothesis with a sufficient score, subsequences of phonemes to words, the pronunciations of which include the phoneme subsequence. The embodiment further uses a statistical language model to determine the likelihood of the proximity of hypothesized words in order to produce a set of word sequence hypotheses and associated scores.

Word recognition gives hypothesis 1 a negligible score because there is no set of words in the pronunciation dictionary with a ZH phoneme that can be ordered to match the phoneme sequence in that hypothesis. Word recognition gives hypothesis 2 a negligible score because, although it matches a sequence of dictionary words, “gone win the wind”, the sequence of the word gone, followed by win is statistically very rare. However, word recognition step 122 gives a considerable score to hypotheses 3 and 4 because they correspond to sequences of words that can commonly come together: “gone within wind” and “gone with the wind”.

Step 123 receives the word sequence hypotheses and associated scores and interprets each word sequence hypothesis with a sufficiently high score according to a multiplicity of natural language grammar rules to produce a set of interpretation hypotheses and associated scores for each word hypothesis grammar rule.

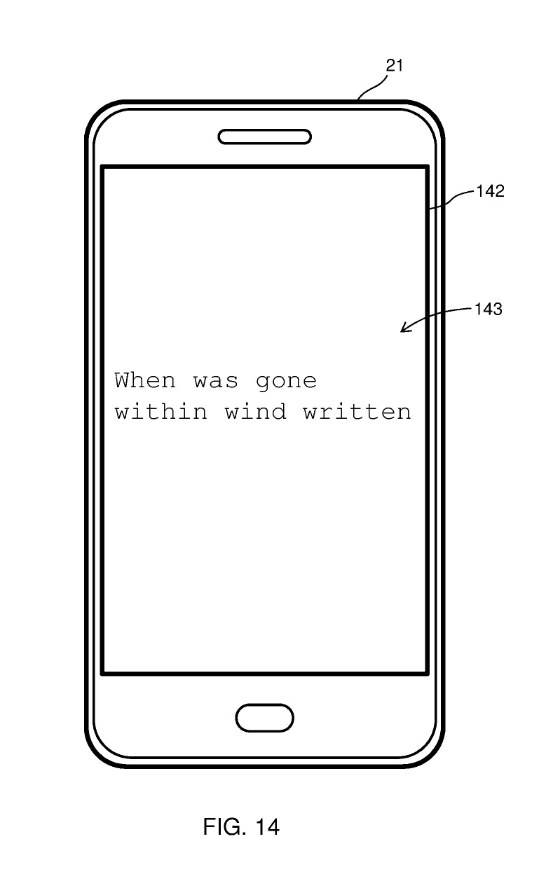

If hypothesis 3 has a significantly higher score from word recognition step 122, it controls the score for grammar interpretation, and the embodiment interprets the command as having the word sequence, “gone within wind”. As a result, as shown in FIG. 14, some embodiments will show a user of client device 21, on display 142, a word sequence 143 of the highest scoring word sequence hypothesis.

The method of FIG. 12 continues in step 124 to receive the interpretation hypotheses, choose the one with the highest score, and determine an appropriate action in response to the speech audio. It produces the action command.

The embodiment of FIG. 12, for each spoken command, stores several of the phoneme sequence hypotheses and word sequence hypotheses with the highest scores in buffer 125. Various technologies are appropriate as media for buffers, such as random access storage devices such as processor registers, random access memory (RAM), Flash storage devices, or hard disk drives. An error identification step 126 observes, in various embodiments, word sequences hypotheses or phoneme sequence hypotheses for spoken commands and compares them to the word or phoneme sequence hypotheses of the immediately prior spoken command.

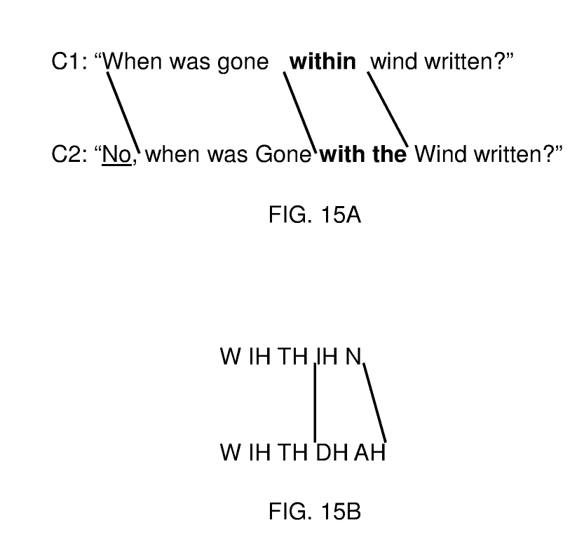

FIG. 15A shows an example of the highest scoring word sequence hypothesis for two successive commands, C1 and C2. The embodiment stores the highest scoring word sequence hypothesis C1 in buffer 125. Upon processing command C2, the embodiment identifies a negative indicator, specifically that the word sequence hypothesis begins with “No . . . ”. The embodiment proceeds to discard the negative indicator, and compare the remaining words in the highest scoring hypotheses for the two commands. When the embodiment identifies a significant match between word hypotheses, such as the five matching words “when”, “was”, “gone”, “wind”, and “written”, and the embodiment identifies a replacement, such as a replacement of a small number of words, such as “within” by the words “with the”, it reasonably concludes that the user's second utterance was an attempt to repeat the same command, but with a correction to an incorrect word sequence hypothesis for C1.

Some embodiments perform comparison at the level of phoneme sequences, instead of, or in addition to, comparison at the level of word sequences. FIG. 15B shows that the two-word replacement results from just a two-phoneme replacement.

Referring again to FIG. 12, some embodiments store in buffer 125 not just the highest scored hypotheses, but the several top scoring hypotheses. When a command has a negative indicator, and identifies a word replacement, such an embodiment checks to see if a somewhat lower scored hypothesis from one or more recent commands did not have the identified word replacement. Some embodiments further check to see if a lower scored hypothesis from the second command matches the top scoring hypothesis of the first command.

Upon identifying a likely word sequence error in the first command, some embodiments send the audio of the first command and the most highly scored hypothesis of the second command. Some embodiments trim words that are new in the second command, such as negative indicator words, before sending. Some embodiments send the audio and hypothesis to human curators to check and confirm that a recognition error actually occurred.

Some embodiments, upon identifying a likely word sequence error in the first command, use the words of the second command that likely match the audio with the same words in the first command to automatically train an acoustic model. By doing so, the system automatically improves its word recognition, especially for the likely errant phonemes, in the presence of noise or for the user's accent and speaking style.

Some embodiments store hypotheses for several commands in sequence, and use only the highest-scoring hypotheses from the last apparently corresponding command in relation to the audio from each of the previous apparently corresponding commands. This handles the case of a user repeatedly trying to get the embodiment to recognize the correct word sequence.

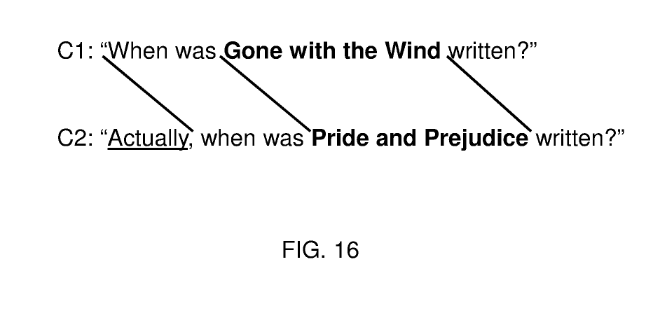

Some embodiments consider negative indicators, except for clarification indicators, in identifying word sequence errors. FIG. 16 shows a scenario for such an embodiment. Commands C2 begins with the clarification indicator “Actually . . . ”. The embodiment identifies a word replacement of “Gone with the Wind” with “Pride and Prejudice”. Such an embodiment appropriately does not send the audio and sequence hypothesis for curation or training.

Various embodiments use different thresholds for the number of words in a word replacement. An embodiment that considers only two-word replacements to be likely words sequence errors appropriately disregards the difference between C1 and C2 in the example of FIG. 16. Embodiments that use phoneme sequence comparison rather than word sequence comparison may have larger threshold numbers of phoneme replacements that indicate errors. An embodiment that uses phoneme sequence replacements of as many as 10 or fewer phonemes to indicate likely errors disregards the scenario of FIG. 16 because the phoneme replacement between “Gone with the Wind” and “Pride and Prejudice” is a replacement of 12 phonemes with 14 phonemes.

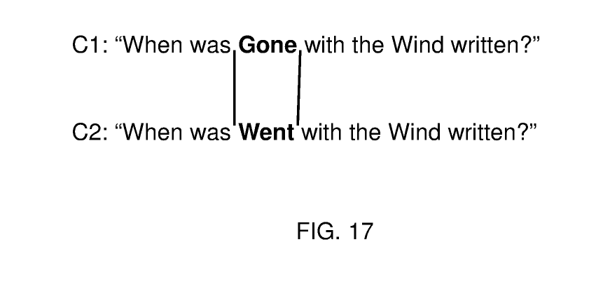

Some embodiments use command word or phoneme hypothesis comparison for all commands. In the scenario of FIG. 17, such an embodiment, with even just a 1-word threshold, might falsely identify the command sequence as having an error. Some embodiments only consider sequential commands that include a negative indicator. Such embodiments would not flag the scenario of FIG. 17 as a likely error.

### Identifying Word Sequence Errors within a Sequence

Some embodiments compute hypotheses of word sequence errors from a single sequence. Some such embodiments do so by identifying repetition of similar words or phoneme sequences.

Some embodiments display a string of text that is the highest scored transcription hypotheses of a user utterance. If so, some users can identify transcription errors as they speak. Some such users attempt to correct transcription errors by repeating a previous part of their utterance. Some embodiments detect repeated nearly identical word or phoneme subsequences and thereby hypothesize a word sequence error.

Some embodiments change the displayed transcription text as speech recognition updates scores of different transcription hypotheses. As a result, sometimes the highest scored hypothesis has an exact duplicate of a phoneme subsequence as a result of user repetition of words.

Some embodiments detect word emphasis, and strengthen the hypothesis of a word sequence error if the second occurrence of the phoneme sequence has significantly greater emphasis.

Some such embodiments compute a higher error hypothesis score as the number of phonemes in the repeated sequence increases. This avoids flagging word sequences spoken by users with natural stutters as being in error.

In one scenario, the text string, “gone with the wind the wind” is a text transcription of the phoneme sequence <G AO N W IH TH DH AH W IH N D DH AH W IH N D>. Some embodiments identify that the last six phonemes are an exact repeat of the prior six phonemes. This indicates that there was likely another word sequence hypothesis with an error, but this word sequence hypothesis is correct, without the repeated phonemes.

In one scenario, the text string, “gone within WITH THE wind” is a text transcription of the phoneme <G AO N W IH TH IH N W IH N D ##W IH TH DH AH##>, including the emphasized phonemes subsequence ##W IH TH DH AH##. Some embodiments identify that a significant part of the emphasized phoneme subsequence (in this case the first three phonemes) match a recent phoneme subsequence. This indicates a user repeating a portion of an incorrectly transcribed word sequence. Some embodiments therefor hypothesize that the matching previous phoneme sequence (<W IH TH IH N> in this scenario) should be replaced by the emphasized phoneme subsequence (<W IH TH DH AH> in this scenario).

### Correcting Word Sequence Errors

Some embodiments comprise a visual display, such as a computer monitor or liquid crystal display (LCD) panel built in to a device screen. Some such embodiments display the words of a highest scored word sequence hypothesis on the visual display. Some embodiments, as they receive sound input, change the scores of competing word sequence hypotheses, and correspondingly change the display to match a new highest scored word sequence hypothesis. Some embodiments use statistical language models to weight word sequence hypothesis scores. Some embodiments use natural language grammar parsing to weight word sequence hypothesis scores.

Some such embodiments further comprise a means for text entry, such as a keyboard, a touch-screen that accepts taps and swipes on a virtual keyboard, and gestures. Some such embodiments accept feedback from a user, either solicited or unsolicited. Such embodiments, in response to receiving negative feedback from a user, ask the user to enter text corresponding to what the user intended the word sequence to be. Some such embodiments do so by providing an empty text box for user entry. Some such embodiments do so by providing a text box populated with the displayed word sequence so that the user need not enter the full utterance text, but just edit an errant part of the word sequence. Some such embodiments present the top few transcription hypotheses to the user as selectable choices. This allows the user to save time by simply choosing, rather than typing, transcription corrections. Some embodiments, in response to negative feedback, present the top few search results and ask the user to choose the one corresponding to the intended interpretation of the utterance.

### Identifying Interpretation Errors

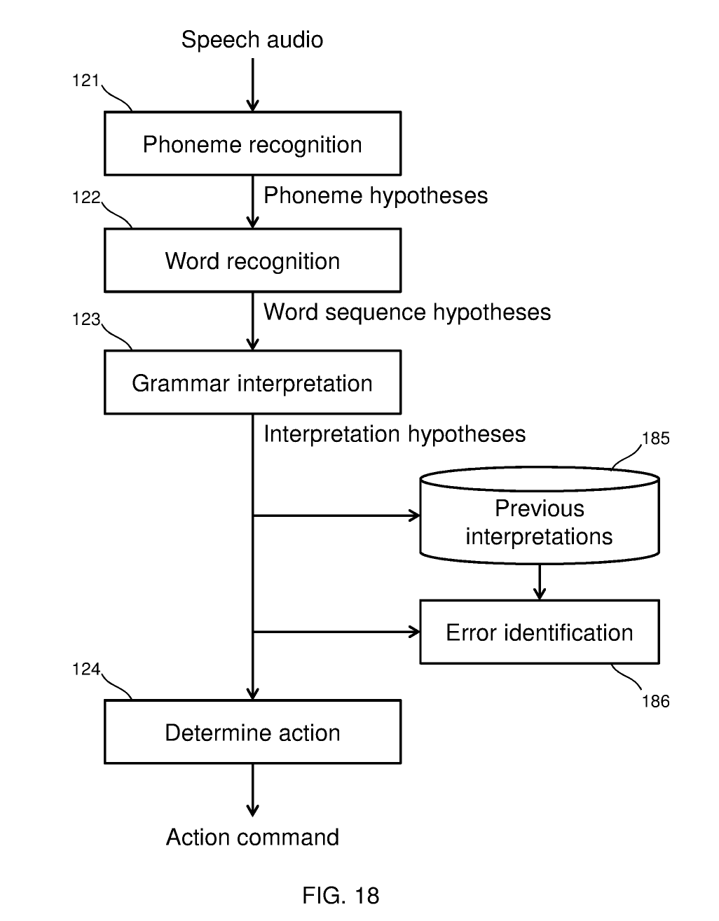

In FIG. 18, some embodiments proceed through grammar interpretation step 123 in order to produce a top-scoring interpretation for action-determining step 124 to produce an action command. FIG. 18 shows such an embodiment. The embodiment of FIG. 18 further stores several of the top-scoring interpretation hypotheses for several of the most recent commands in a buffer 185. It further proceeds with an error identification step 186.

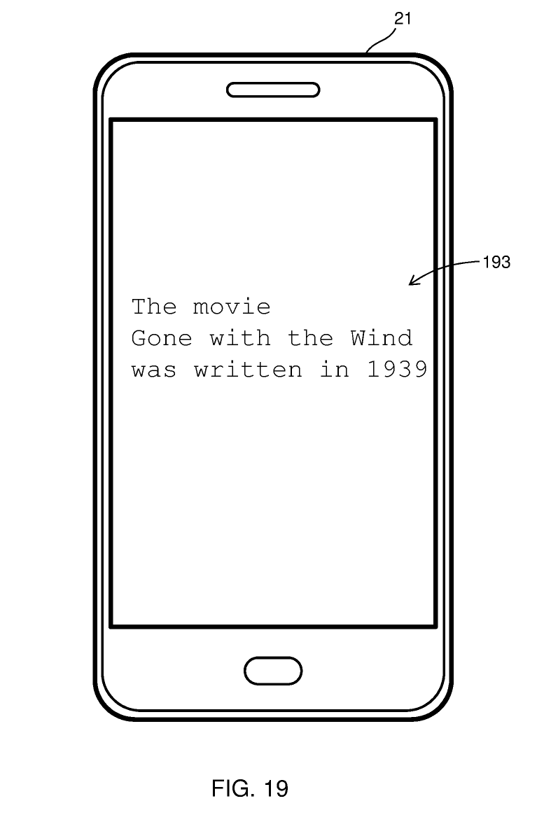

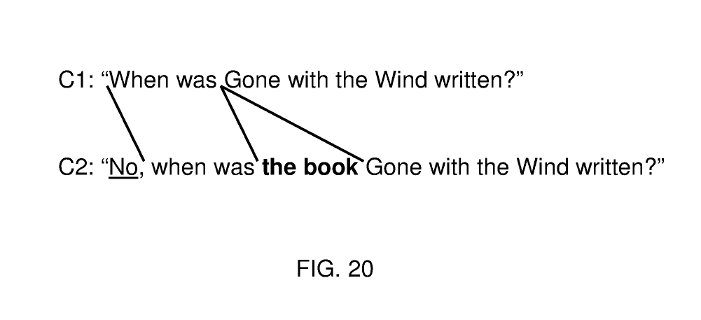

FIG. 19 shows an example of client device 21 displaying an action result, “The movie Gone with the Wind was written in 1939” in response to a command, C1, of, “When was Gone with the Wind written?”. FIG. 20 shows command C1 and a user's following command C2. Command C2 includes negative indicator word “No . . . ”. It also includes no replacement, but an addition of words, “the book”. The embodiment of FIG. 18 in the scenario of FIG. 20 determines that the interpretation of command C1 was likely in error. The fact that the user added words to the otherwise matching command implies the interpretation error.

Various embodiments use different thresholds for maximum numbers of word additions that distinguish between a likely interpretation error and an unrelated command. Some embodiments send the interpretation of the second command and the word sequence hypothesis of the first command for curation or for automatic training of natural language grammar rules.

Various embodiments detect one or more of likely phoneme sequence errors, likely word sequence errors, and likely interpretation errors.

Some embodiments compare interpretations between C2 and buffered commands other than the most recent. For example, a sequence of commands, “Send Bob a message”, “Cancel”, “Send Bob Loblaw a message”. Such embodiments compare the first and third command to detect likely interpretation errors, and identify the second command, “Cancel”, as a negative indicator that justifies sending the likely error.

Some embodiments store a timestamp with hypotheses in buffer 125 of FIG. 12 and buffer 185 of FIG. 18. A timestamp is any numerical indicator of the time that an event occurred. Many formats are appropriate, such as a set of values each representing one of a year, month, day, hour, minute, second, and microsecond. Another format would be a single value representing the number of seconds that have elapsed since 00:00:00 Coordinated Universal Time (UTC), Thursday, 1 Jan. 1970, not counting leap seconds.

Some embodiments only send likely errors for curation or automatic training if the time of command C2 is within a specified duration of the timestamp of C1. This avoids false error indications due to transcriptions between different user sessions.

### Physical Implementation

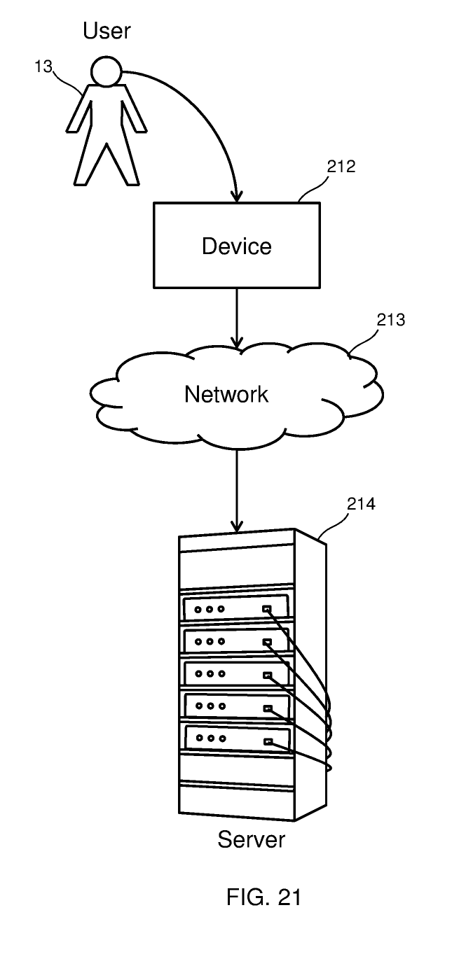

Some embodiments run entirely on a user device. Some embodiments use client-server interaction for reasons such as the server having more processor performance in order to give better quality of results. FIG. 21 shows one such embodiment. A user 13 speaks audio to a device 212, which sends the audio over a network 213 to a rack-mounted server 214 in the server farm of a data center. The server 214 processes the audio and carries out method steps 11 and 12. It sends the result through network 213 to device 212, which provides it to user 13. In response, user 13 speaks utterance audio, which the device 212 receives and sends over network 213 to server 214 and server 214 carries out method steps 14 and 15 to identify satisfaction indicators.

An article of manufacture (e.g., computer or computing device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool.

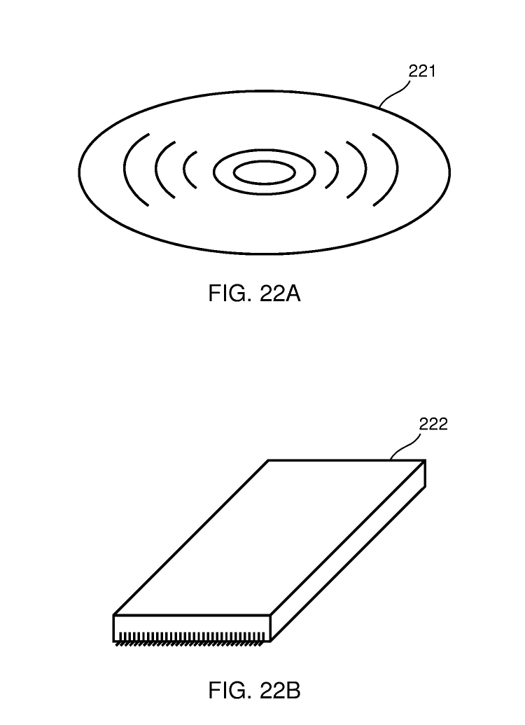

Modern virtual assistants work by executing software on computer processors. Various embodiments store software for such processors as compiled machine code or interpreted code on non-transitory computer readable media. FIG. 22A and FIG. 22B show examples of non-transitory computer readable media. FIG. 22A shows a magnetic disk 221. FIG. 22B shows a Flash RAM device 222.

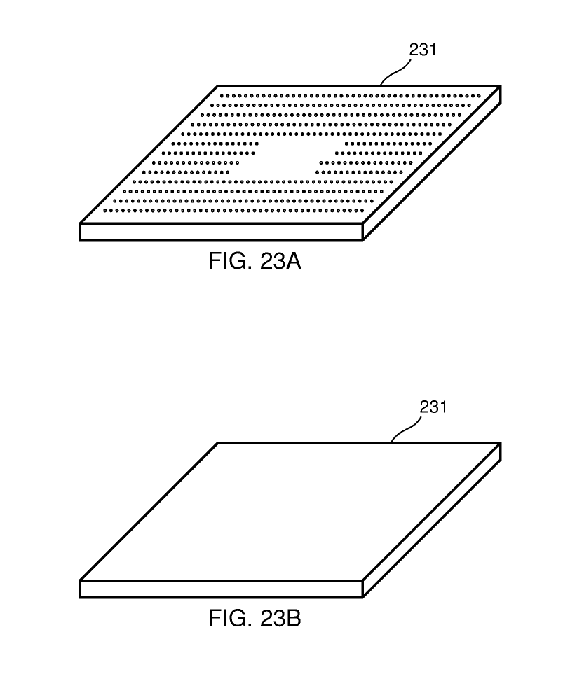

FIG. 23A and FIG. 23B show various embodiments of a processor chip package. FIG. 23A shows a side of a chip package 231 with a visible ball grid array for solder-mounting the chip to a printed circuit board. FIG. 23B shows the other side of the chip package 231, from which the ball grid array is not visible.

Various embodiments use general purpose processors with instruction sets such as the x86 instruction set, graphics processors, embedded processors such as ones in systems-on-chip with instruction sets such as the ARM instruction set, and application-specific processors embedded in field programmable gate array chips.

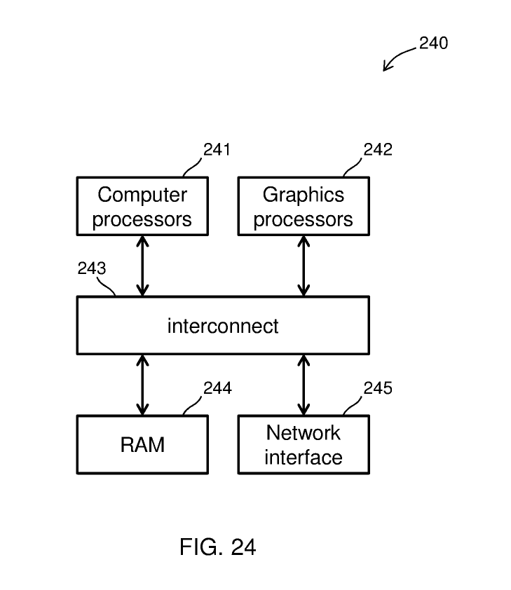

FIG. 24 shows a functional diagram of a server processor 240. It comprises a computer processor unit (CPU) 241 and a graphic processor unit (GPU) 242, each of which connects through interconnected 243 to both of a RAM 244 and network interface 245 from which the processors execute instructions and exchanges data.

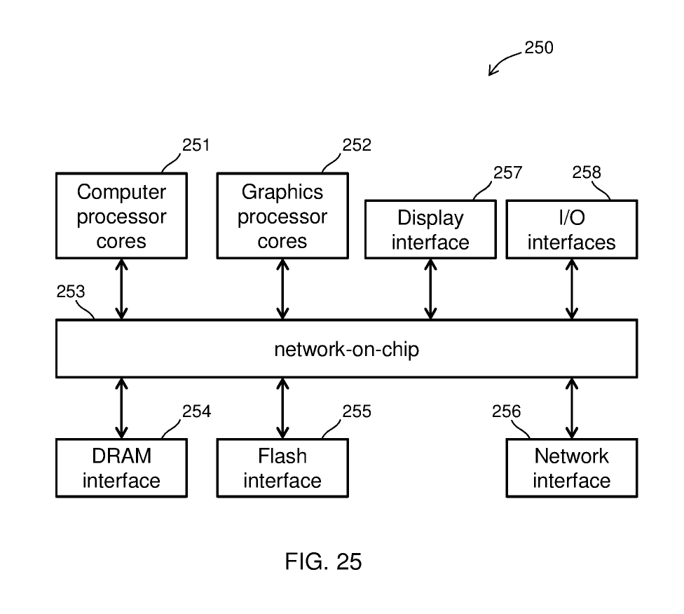

FIG. 25 shows a functional diagram of a SoC 250. It comprises a multicore processor 251 and a multicore GPU 252, each of which is connected through a network-on-chip (NoC) 253 to all of a dynamic random access memory (DRAM) interface 254, Flash interface 255, and network interface 256. SoC 250 provides a user display through display interface 257 and provides a user interface through input/output (I/O) interface 258.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, systems, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention.

In other embodiments, the creation or amendment of the computer-aided design is implemented as a web-based software application in which portions of the data related to the computer-aided design or the tool or the computer readable program code are received or transmitted to a computing device of a host. In addition, while a particular feature of the invention may have been disclosed with respect to only one of several embodiments, such feature may be combined with one or more other features of the other embodiments as may be desired and advantageous for any given or particular application.

The behavior of either or a combination of humans and machines (instructions that, when executed by one or more computers, would cause the one or more computers to perform methods according to the invention described and claimed and one or more non-transitory computer readable media arranged to store such instructions) embody methods described and claimed herein. Each of more than one non-transitory computer readable medium needed to practice the invention described and claimed herein alone embodies the invention.

Some embodiments of physical machines described and claimed herein are programmable in numerous variables, combinations of which provide essentially an infinite variety of operating behaviors. Some embodiments of hardware description language representations described and claimed herein are configured by software tools that provide numerous parameters, combinations of which provide for essentially an infinite variety of physical machine embodiments of the invention described and claimed. Methods of using such software tools to configure hardware description language representations embody the invention described and claimed. Physical machines can embody machines described and claimed herein, such as: semiconductor chips; hardware description language representations of the logical or functional behavior of machines according to the invention described and claimed; and one or more non-transitory computer readable media arranged to store such hardware description language representations.

In accordance with the teachings of the invention, a computer and a computing device are articles of manufacture. Other examples of an article of manufacture include: an electronic component residing on a motherboard, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

The scope of the invention, therefore, is not intended to be limited to the exemplary embodiments shown and described herein. Rather, the scope and spirit of present invention is embodied by the appended claims.

1-13. (canceled)

14. A non-transitory computer readable medium comprising code that, if executed by at least one computer processor comprised by a virtual assistant, would cause the virtual assistant to:
receive a first utterance;
recognize a first sequence of words and an alternative sequence of words from the first utterance;
receive a second utterance;
recognize a second sequence of words from the second utterance;
identify that the second sequence of words matches the alternative sequence of words; and
conclude that the first sequence of words had a speech recognition error.

15-22. (canceled)

23. A non-transitory computer readable medium comprising code that, if executed by at least one computer processor comprised by a virtual assistant, would cause the virtual assistant to:
receive a first utterance;
recognize a first sequence of words from the first utterance;
interpret the first sequence of words to create a first interpretation;
interpret the first sequence of words to create an alternative interpretation;
receive a second utterance;
recognize a second sequence of words from the second utterance;
interpret the second sequence of words to create a second interpretation;
identify that the second interpretation matches the alternative interpretation; and
conclude that the first interpretation had an interpretation error.

24. The non-transitory computer readable medium of claim 23, wherein the code, if executed by the at least one computer processor, would further cause the virtual assistant to display results of the first interpretation and results of the alternative interpretation to the user.

25. The non-transitory computer readable medium of claim 14, wherein the code, if executed by the at least one computer processor, would further cause the virtual assistant to display the first sequence of words and the alternative sequence of words to the user.

26. The non-transitory computer readable medium of claim 14, wherein the code, if executed by the at least one computer processor, would further cause the virtual assistant to:
identify the presence of one or more indicator words in the second sequence of words; and
discard the indicator words prior to identifying that the second sequence of words matches the alternative sequence of words.

27. A method of identifying speech recognition errors, the method comprising:
receiving a first utterance;
recognizing a first sequence of words and an alternative sequence of words from the first utterance;
receiving a second utterance;
recognizing a second sequence of words from the second utterance;
identifying that the second sequence of words matches the alternative sequence of words; and
concluding that the first sequence of words had a speech recognition error.

28. The method of claim 27 further comprising:
displaying the first sequence of words and the alternative sequence of words to the user.

29. The method of claim 27 further comprising:
identifying the presence of one or more indicator words in the second sequence of words; and
discarding the indicator words prior to identifying that the second sequence of words matches the alternative sequence of words.

30. A method of identifying speech recognition errors, the method comprising:
receiving a first utterance;
recognizing a first sequence of words from the first utterance;
interpreting the first sequence of words to create a first interpretation;
interpreting the first sequence of words to create an alternative interpretation;
receiving a second utterance;
recognizing a second sequence of words from the second utterance;
interpreting the second sequence of words to create a second interpretation;
identifying that the second interpretation matches the alternative interpretation; and
concluding that the first interpretation had an interpretation error.

31. The method of claim 30 further comprising:
displaying results of the first interpretation and results of the alternative interpretation to the user.

32. An error-detecting speech recognition device comprising:
a speech recognition module that:
from a first speech utterance, produces a first sequence of words and an alternative sequence of words; and
from a second speech utterance, produces a second sequence of words; and
an identification module that identifies that the second sequence of words matches the alternative sequence of words,
wherein it can be concluded that the first sequence of words had a speech recognition error.

33. The error-detecting speech recognition device of claim 32 further comprising:
a module for displaying the first sequence of words and the alternative sequence of words to the user.

34. The error-detecting speech recognition device of claim 32 wherein the identification module:
identifies the presence of one or more indicator words in the second sequence of words; and
discards the indicator words prior to identifying that the second sequence of words matches the alternative sequence of words.

35. An error-detecting speech recognition device comprising:
a speech recognition module that:
from a first speech utterance, produces a first sequence of words and an alternative sequence of words; and
from a second speech utterance, produces a second sequence of words;
an interpretation module that:
interprets the first sequence of words to create a first interpretation;
interprets the alternative sequence of words to create an alternative interpretation; and
interprets the second sequence of words to create a second interpretation; and
an identification module that identifies that the second interpretation matches the alternative interpretation,
wherein it can be concluded that the first sequence of words had a speech recognition error.

36. The error-detecting speech recognition device of claim 35 further comprising a module for displaying results of the first interpretation and results of the alternative interpretation to the user.
